(19) United States
(12) Patent Application Publication
(10) Pub. No.: US 2008/0298716 A1
(43) Pub. Date: Dec. 4, 2008

(54) Solid-State Imaging Device and Pixel Correction Method

(75) Inventor: Seiji YAMAGATA, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/130,437

(22) Filed: May 30, 2008

(30) Foreign Application Priority Data
May 31, 2007 (JP) 2007-144331

(51) Int. Cl. G06K 9/40

(52) U.S. Cl. 382/275

(57) ABSTRACT

A solid-state imaging device capable of correcting defective pixel signals to improve image quality. A line memory provides a value of a pixel currently selected for correction, together with values of its surrounding pixels. The surrounding pixels include corrected pixels preceding the selected pixel and uncorrected pixels succeeding the selected pixel. An extreme value remover removes effectively a maximum and minimum pixel values from the values of the corrected pixels read out of the line memory. An average calculator calculates an average value of the remaining uncorrected pixels and the corrected pixels read out of the line memory. A comparison processor compares the value of the selected pixel with the average value. If their difference exceeds a predetermined threshold, the comparison processor replaces the value of the selected pixel with the average value.

### CROSS-REFERENCE TO RELATED APPLICATIONS

This application is based upon and claims the benefits of priority from the prior Japanese Patent Application No. 2007-144331, filed on May 31, 2007, the entire contents of which are incorporated herein by reference.

### BACKGROUND

1. Field

The embodiments discussed herein are directed to a solid-state imaging device and a pixel correction method. The embodiment may relate to a solid-state imaging device with the function of correcting defective pixels in a picture, as well as to a method of correcting defective pixels in a picture.

2. Description of the Related Art

Solid-state imaging devices such as complementary metal-oxide semiconductor (CMOS) image sensors have a color filter placed over their photo diode array to capture color images. Incoming light passes through the color filter and reaches each photo diode, where the optical image is converted to electric signals. The output of such imaging devices may, however, contain some defects or noise disturbance. The output signal is therefore subjected to a defect correction and noise suppression process, which replaces a defective pixel signal with a signal of another pixel preceding or succeeding that pixel in question. See, for example, Japanese Unexamined Patent Application Publication Nos. 2001-307079 and 2002-300404.

FIG. 10 illustrates an image sensor with an RGB Bayer filter, where the symbol R represents red pixels, G1 and G2 green pixels, and B blue pixels. Suppose now that a blue pixel 90 is currently selected for defect correction and noise suppression. The correction process first calculates the average of eight blue pixels 91 to 98 surrounding the current pixel 90. If the value of the current pixel 90 equals or exceeds a threshold, the correction process replaces the current pixel value with the average value of the surrounding pixels 91 to 98. This conventional algorithm, however, has a drawback discussed below.

FIG. 11 gives a simplified view of the pixel array of FIG. 10, where only blue pixels are shown for the sake of explanation. The symbol C90 represents a currently selected pixel. The symbols A90, A91, A92, A93, and A94 represent pixels that have already been corrected, while B90, B91, B92, B93, and B94 represent pixels that are waiting correction. As FIG. 11 shows, the selected pixel C90 is surrounded by eight pixels, A91 to A94 and B91 to B94. The latter four surrounding pixels (B91 to B94) have not been corrected, meaning that they could have a defect or could be disturbed by noise. Such defects or noise, if present, would produce an error in the average value calculated assuming replacement of the selected pixel value.

### SUMMARY

It is an aspect of the embodiments discussed herein to provide a solid-state imaging device capable of correcting defective pixel signals, the device including: a line memory that provides values of a pixel currently selected for correction and surrounding pixels thereof, the surrounding pixels including corrected pixels preceding the selected pixel and uncorrected pixels succeeding the selected pixel; an extreme value remover that removes effectively a maximum pixel value and a minimum pixel value from the values of the corrected pixels read out of the line memory; an average calculator that receives the remaining values of the uncorrected pixels from the extreme value remover, as well as the values of the corrected pixels from the line memory, and calculates an average value of all the pixel values received; and a comparison processor that compares the value of the currently selected pixel with the average value calculated by the average calculator and, if a difference therebetween exceeds a predetermined threshold, replaces the value of the currently selected pixel with the average value.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 gives an overview.

FIG. 2 is a block diagram of a solid-state imaging device according to an embodiment.

FIG. 3 shows an internal structure of a logic circuit.

FIG. 4 is a flowchart of a process executed by an RGB processor as part of the logic circuit.

FIG. 5 shows, in a simplified form, how lines of pixels are obtained.

FIG. 6 is a block diagram showing a first specific example of the RGB processor.

FIG. 7 is a block diagram showing a second specific example of the RGB processor.

FIG. 8 shows the range of pixels processed by an RGB processor according to a third specific example.

FIG. 9 is a block diagram of the RGB processor according to the third specific example.

FIG. 10 illustrates an image sensor with an RGB Bayer filter.

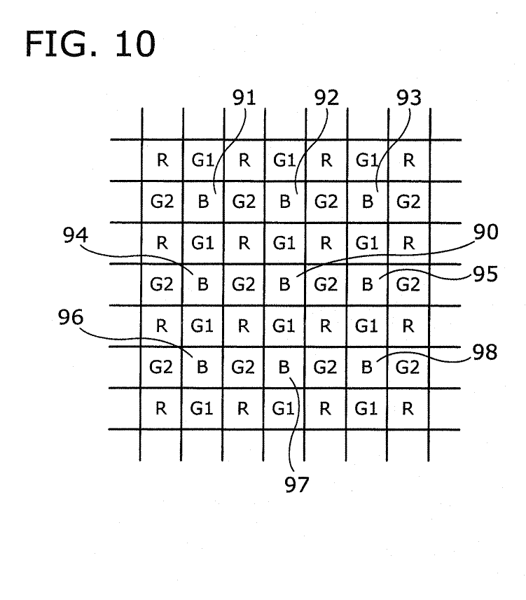

FIG. 11 gives a simplified view of the pixel array of FIG. 10, where only blue pixels are shown for the sake of explanation.

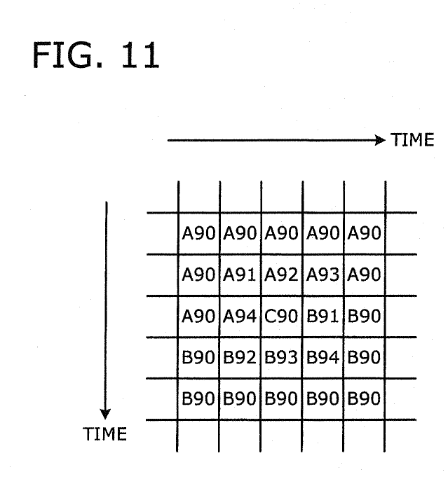

### DESCRIPTION OF THE PREFERRED EMBODIMENTS

Preferred embodiments will now be described in detail below with reference to the accompanying drawings, wherein like reference numerals refer to like elements throughout. The description begins with an overview and then proceeds to a more specific embodiment of the invention.

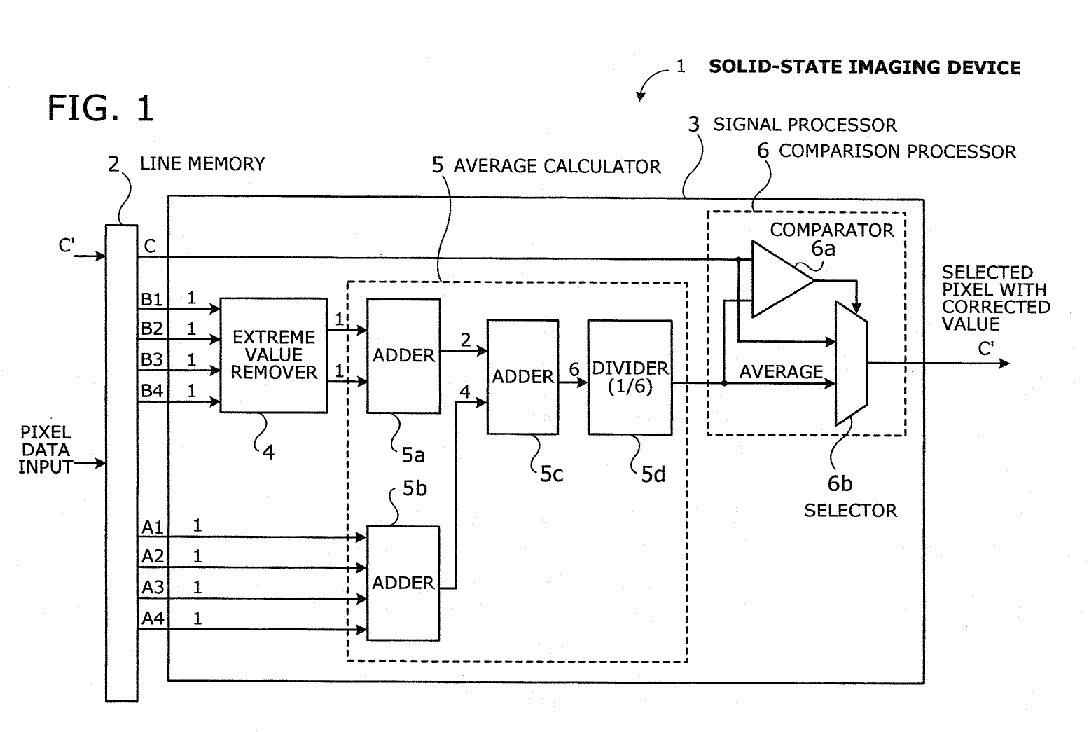

FIG. 1 gives an overview. The illustrated solid-state imaging device 1 includes an image sensor (not shown), a line memory 2, and a signal processor 3. The image sensor has a color filter configured in the RGB Bayer pattern.

The line memory 2 outputs the values of a pixel currently selected for correction and its surrounding pixels. Here, the surrounding pixels are divided into two groups: (a) corrected pixels preceding the selected pixel, and (b) uncorrected pixels succeeding the selected pixel.

The signal processor 3 processes digital image signals supplied from an image sensor through an analog-to-digital (A/D) converter (both not shown). To this end, the signal processor 3 is formed from an extreme value remover 4, an average calculator 5, and a comparison processor 6.

Specifically, the extreme value remover 4 removes effectively a maximum pixel value and a minimum pixel value (i.e., extreme values) from the group of corrected pixel values read out of the line memory 2. In the example shown in FIG. 1, the signal processor 3 is designed to process eight pixels surrounding a specific pixel selected for correction. The symbols B1 to B4 represent four pixels succeeding the selected pixel, which are waiting correction by the signal processor 3 and thus referred to as uncorrected pixels. The extreme value remover 4 compares the values of those uncorrected pixels B1 to B4 with each other, thus finding a maximum pixel value and a minimum pixel value among them. The extreme value remover 4 outputs the remaining two pixel values (i.e., rejecting the maximum and minimum values that are found).

To facilitate the reader's understanding, FIG. 1 shows the number of pixel values contained in each input of functional blocks of the signal processor 3. For example, the numeral “2” placed at an input indicates that the input receives a sum of two pixel values.

The average calculator 5 receives the remaining values of uncorrected pixels from the extreme value remover 4, as well as the corrected pixel values read out of the line memory 2. The average calculator 5 then calculates the average of all those received pixels.

To realize the above averaging function, the average calculator 5 contains three adders 5a, 5b, and 5c and a divider 5d as depicted in FIG. 1. The first adder 5a adds up two pixel values that the extreme value remover 4 outputs as remaining pixel values after the removal of maximum and minimum values. The second adder 5b adds up the values of four pixels A1 to A4 that have already been corrected. The third adder 5c adds up the two-pixel sum calculated by the first adder 5a and the four-pixel sum calculated by the second adder 5b. The resulting sum thus contains six pixel values. The divider 5d then divides this sum by six, thereby calculating the average of the six pixel values.

The comparison processor 6 compares the original value of the selected pixel C with the average pixel value calculated by the average calculator 5. If their difference exceeds a predetermined threshold, the comparison processor 6 replaces the value of the selected pixel C with the average pixel value.

To realize the above function, the comparison processor 6 shown in FIG. 1 has a comparator 6a and a selector 6b. The comparator 6a compares the value of the selected pixel C with an average value supplied from the divider 5d. If their difference exceeds a predetermined threshold, the comparator 6a activates its output. The selector 6b uses this comparison result to choose either the current value of pixel or the average value. Specifically, the selector 6b chooses the average value for the selected pixel C in the case where the output of the comparator 6a is activated. The selector 6b otherwise outputs the original value of pixel C. FIG. 1 shows a symbol C′ to represent the selected pixel with such a corrected value.

The above-described solid-state imaging device 1 operates as follows, assuming that a specific pixel C is selected for correction. The value of the selected pixel is read out of the line memory 2, along with those of its surrounding pixels. The surrounding pixels include those preceding the selected pixel and those succeeding the selected pixel. From the latter group of pixels, the extreme value remover 4 removes both maximum-valued and minimum-valued pixels effectively. The average calculator 5 calculates the average value of such surrounding pixels, excluding maximum-valued and minimum-valued pixels succeeding the currently selected pixel. The comparison processor 6 compares the selected pixel value with the average pixel value calculated by the average calculator 5. If their difference exceeds a predetermined threshold, the comparison processor 6 substitutes the average pixel value for the selected pixel.

### Solid-State Imaging Device

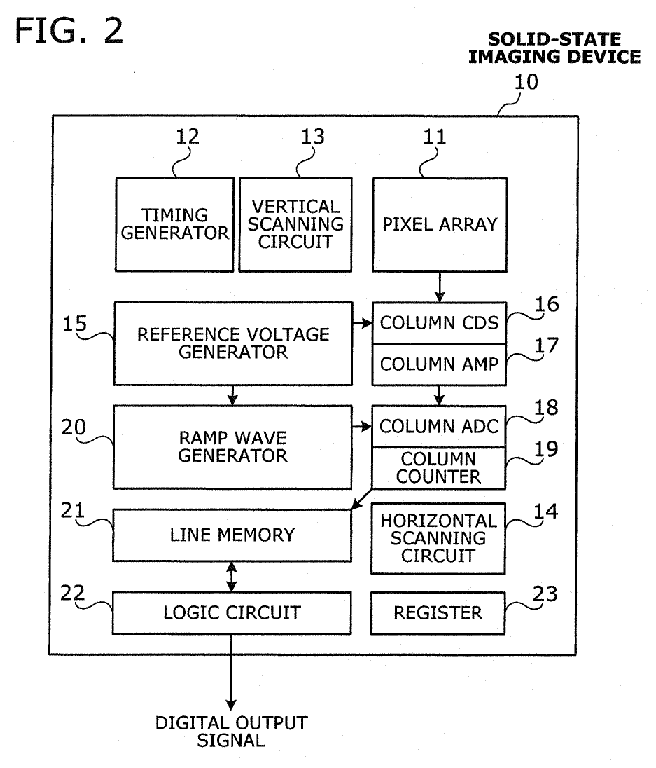

Referring now to the block diagram of FIG. 2, this section will describe a solid-state imaging device according to an embodiment. The illustrated solid-state imaging device 10 includes the following elements: a pixel array 11, a timing generator 12, a vertical scanning circuit 13, a horizontal scanning circuit 14, a reference voltage generator 15, a column correlated double sampling (column CDS) 16, a column amplifier (column AMP) 17, a column analog-to-digital converter (column ADC) 18, a column counter 19, a ramp wave generator 20, a line memory 21, a logic circuit 22, and a register 23.

The pixel array 11 is an array of pixels arranged in the form of a two-dimensional matrix, each pixel having a photo sensing element formed from a photodiode and MOS transistors. The timing generator 12 provides pulse signals for use in the vertical scanning circuit 13 and horizontal scanning circuit 14. The vertical scanning circuit 13 selects pixels sequentially in the column direction, while the horizontal scanning circuit 14 selects pixels sequentially in the row direction.

The reference voltage generator 15 generates reference voltages for use in several sections of the device. The column CDS 16 rejects amplifier noise and reset noise produced in the pixel array 11. The column AMP 17 adjusts the sensor output level such that it falls within an input dynamic range of the column ADC 18. The column ADC 18 converts a given analog voltage to a digital value. The column counter 19 counts digital values for output of the column ADC 18. The ramp wave generator 20 produces a ramp wave increasing at a constant rate for use in the column ADC 18.

The line memory 21 is a semiconductor memory used as temporary storage of output image signals from the column counter 19 and logic circuit 22. This line memory 21 offers a memory area for each different line of the pixel array 11. The stored image signals are supplied to the logic circuit 22. The register 23 stores various user-defined parameters for use in the logic circuit 22.

### RGB Processor

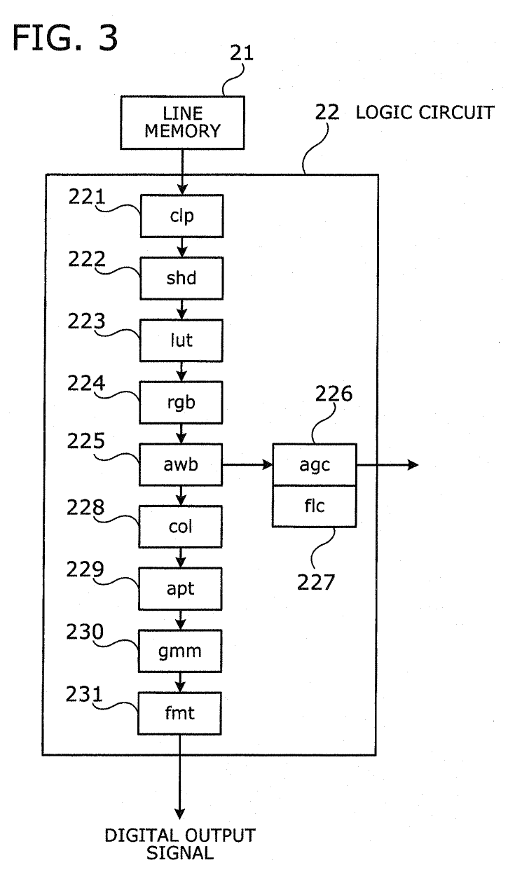

FIG. 3 shows an internal structure of the logic circuit 22. The logic circuit 22 receives AD-converted pixel values via the line memory 21. To process those digital pixel values, the logic circuit 22 includes the following elements: a digital clamping processor (clp) 221 to remove offset components so that the minimum pixel values will represent black; a shading corrector (shd) 222; a gain controller (lut) 223; an RGB processor (rgb) 224 to perform defect correction, color interpolation, noise suppression, etc.; an automatic white balance processor (awb) 225 to adjust white balance; an automatic gain controller (agc) 226 to adjust chrominance gain, a flicker canceller (flc) 227 to automatically detect and remove flicker noise in a picture; a color controller (col) 228, an edge sharpener (apt) 229 to enhance edges and suppress noise; a gamma corrector (gmm) 230 to apply gamma correction; and a format converter (fmt) 231 to convert the signal format and produce a digital output signal.

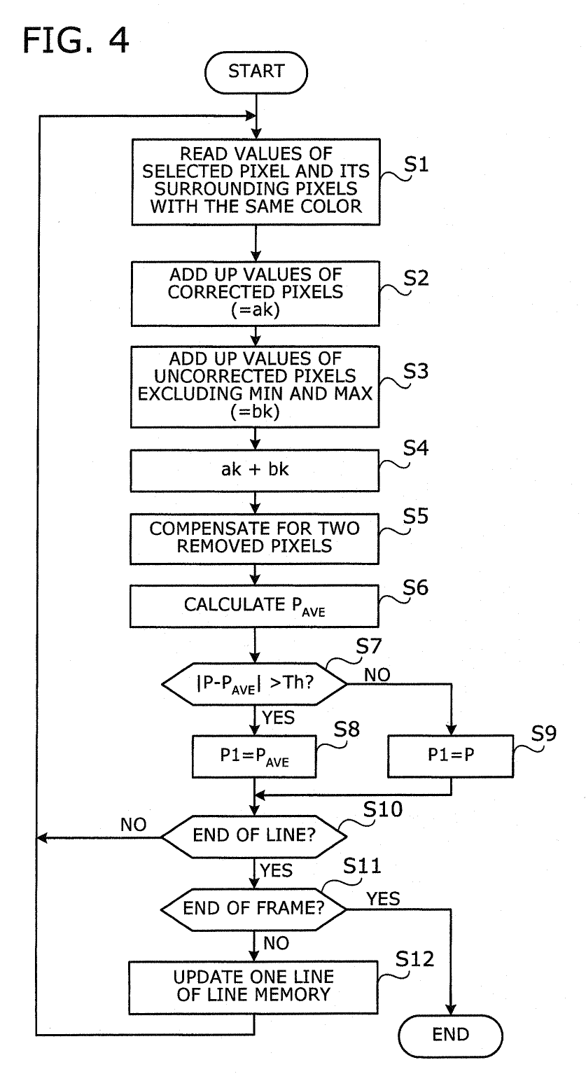

Referring to the flowchart of FIG. 4, the RGB processor 224 operates in the logic circuit 22 as follows:

The RGB processor 224 begins its task with reading pixel values from the column ADC 18 and line memory 21 for one selected pixel for correction and its surrounding pixels with the same color on one line (step S1). Some of those surrounding pixels have already been corrected by the RGB processor 224, and others have not. The RGB processor 224 adds up the values of the former group of surrounding pixels (i.e., corrected pixels), thus producing a sum ak (step S2). The RGB processor 224 then adds up the other group of surrounding pixels (i.e., uncorrected pixels) after effectively removing the maximum and minimum ones, thus producing another sum bk (step S3). The RGB processor 224 calculates the sum of ak and bk (step S4). The RGB processor 224 then adds some appropriate value to the result of step S4 to compensate for the two removed pixels (step S5). The RGB processor 224 calculates an average pixel value P_{AVE} from the result of step S5 (step S6). That is, P_{AVE} represents the average of surrounding pixels with the same color as the selected pixel, excluding both maximum and minimum extremes from those read out of the line memory 2 at step S1.

The RGB processor 224 now turns to the currently selected pixel. This pixel has a value of P, which has been obtained at step S1. The RGB processor 224 determines whether the absolute difference between P and P_{AVE} is greater than a defect detection threshold Th (step S7). If the absolute difference is greater than Th (i.e., if Yes at step S7), then the selected pixel takes the average P_{AVE} as its new corrected value P1 (step S8). If the absolute difference is equal to or smaller than Th, then the selected pixel maintains its original value P (step S9), meaning that P1 equals P.

The logic circuit 22 determines whether all pixels on the current line have undergone steps S1 to S9 (step S10). In other words, it determines whether the entire line is finished. If there are uncorrected pixels on the current line (i.e., if No at step S10), the RGB processor 224 returns to step S1 to repeat the foregoing steps to correct the next uncorrected pixel on the current line.

If the entire line is finished (or if Yes at step S10), the logic circuit 22 then determines whether the entire frame is finished (step S11). If there are uncorrected lines (or if No at step S11), the line memory 21 is updated with the finished line (step S12), and the process returns to step S1 to repeat the foregoing steps to correct the next uncorrected line. If the entire frame is finished (or if Yes at step S11), the process is terminated.

### First Specific Example of RGB Processor

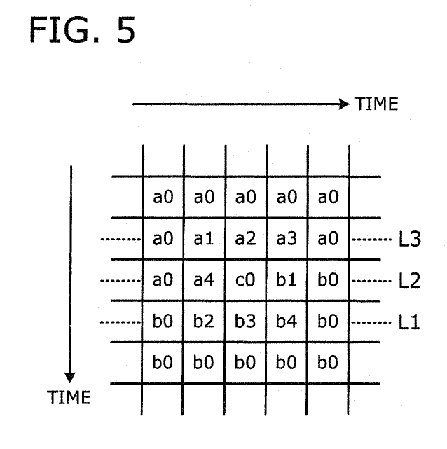

The process described in FIG. 4 will now be discussed in greater detail with reference to a more specific example. FIG. 5 shows, in a simplified form, how lines of pixels are obtained. Pixel c0 is currently selected for correction. Preceding pixels a0, a1, a2, a3, and, a4 have already been corrected, while succeeding pixels b0, b1, b2, b3, and b4 have not.

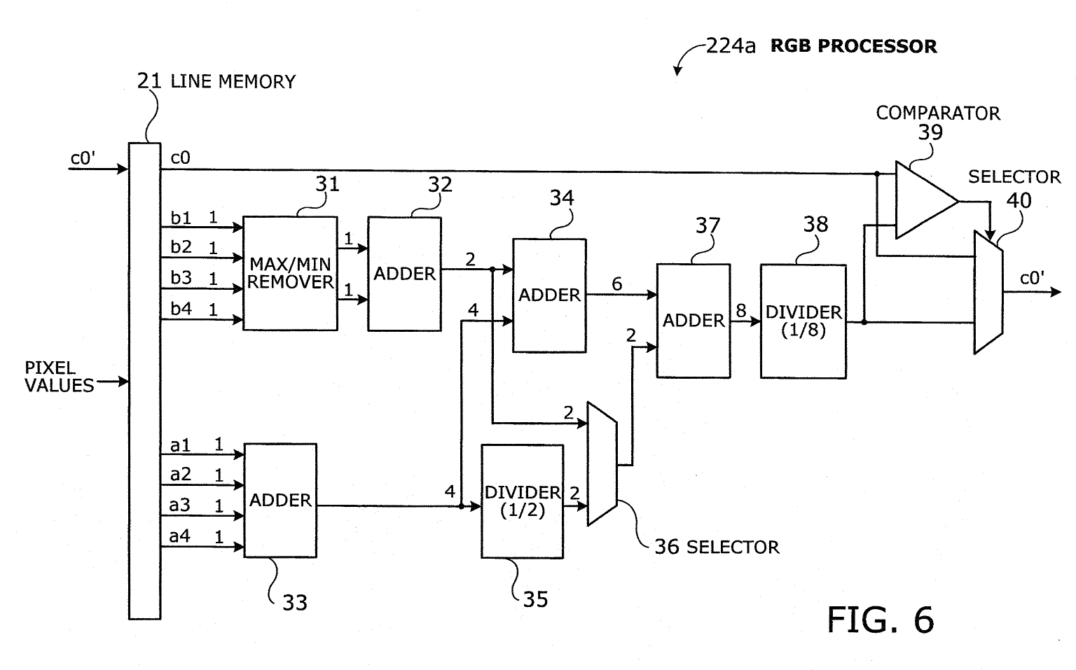

FIG. 6 shows a circuit structure of a first specific example of the RGB processor 224. Suppose now that the logic circuit 22 has pixel values of one line L1 supplied via the column ADC 18 and column counter 19, along with those of two lines L2 and L3 supplied from the line memory 21. Pixel c0 is currently selected for correction. In addition to the value of this pixel c0, the illustrated RGB processor 224a receives values of its surrounding pixels a1 to a4 and b1 to b4. The preceding pixels a1 to a4 have already corrected by the RGB processor 224a and are now fed back to the RGB processor 224a, whereas the succeeding pixels b1 to b4 have not been corrected.

The RGB processor 224 shown in FIG. 6 is formed from the following elements: a MAX/MIN remover 31, four adders 32, 33, 34, and 37, two dividers 35 and 38, two selectors 36 and 40, and a comparator 39.

The MAX/MIN remover 31 receives values of uncorrected pixels b1 to b4 from the line memory 21. The MAX/MIN remover 31 removes a maximum value and a minimum value from those received pixel values, and the first adder 32 adds up the remaining two pixels. The second adder 33, on the other hand, adds up the values of four corrected pixels a1 to a4 supplied from the line memory 21. The third adder 34 further adds up the outputs of the first and second adders 32 and 33.

The first divider 35 divides the output of the second adder 33 (i.e., the sum of four corrected pixel values) by two. Then the first selector 36 selects either the output of the first adder 32 (i.e., the sum of two remaining pixel values) or the output of the first divider 35 (which is equivalent to two average corrected pixel values). The user may explicitly specify which to select. Or alternatively, the first selector 36 may follow a factory-default selection.

The fourth adder 37 adds up the six-pixel sum output of the third adder 34 and the two-pixel sum output of the first selector 36. The second divider 38 divides the eight-pixel sum output of the fourth adder 37 by eight, thereby producing what has been described in FIG. 4 as the average value P_{AVE}.

The comparator 39 compares the division result of the second divider 38 with the value of the selected pixel c0, which is supplied from the line memory 21. More specifically, the comparator 39 calculates the difference between the value of the selected pixel c0 and the average of its surrounding pixels. If the difference exceeds a predetermined threshold (specifically, defect detection threshold Th), the comparator 39 activates its output from low to high, for example.

The second selector 40 chooses either the original value of the selected pixel c0 or the average of its surrounding pixels, based on the comparison result of the comparator 39. This output of the second selector 40 is used to correct the currently selected pixel c0. Specifically, if the comparator 39 activates its output, the second selector 40 selects the average value and writes it in the line memory 21 as a corrected value of the selected pixel c0. If the output of the comparator 39 stays inactive, the second selector 40 selects the original value of pixel c0 and writes it in the line memory 21. This pixel c0 will be referenced later as a corrected pixel a1, a2, a3, or a4 since it has undergone a correction process.

The above-described circuit of FIG. 6 provides the processing function discussed in FIG. 4. Note that input values for the second divider 38 are always a power of 2. This fact simplifies division operations performed by the second divider 38. For example, the second divider 38 can be implemented by using a shift register.

### Second Specific Example of RGB Processor

This section describes a second specific example of the RGB processor 224. Since the second specific example is mostly similar to the foregoing first specific example, the description will focus on their differences without repeating the explanation for their shared features.

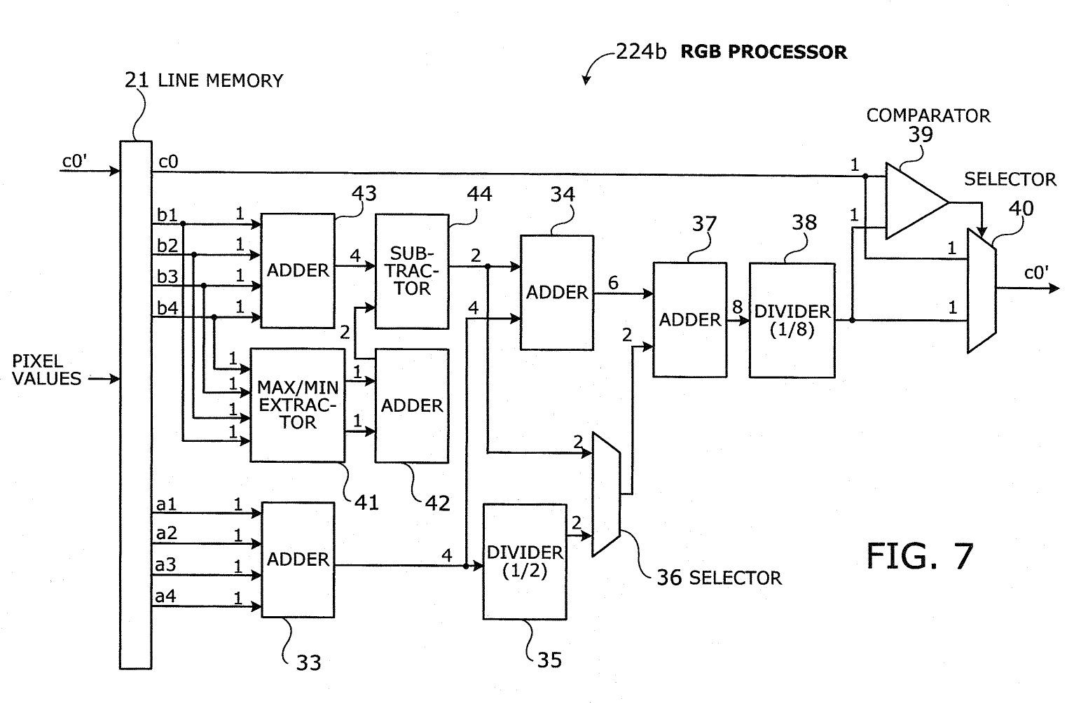

The second specific example differs from the first specific example in the way of creating input values for the adder 34. FIG. 7 is a block diagram showing an RGB processor 224b according to the second specific example. This RGB processor 224b employs a MAX/MIN extractor 41, two adders 42 and 43, and a subtractor 44, in place of the MAX/MIN remover 31 and first adder 32 discussed in FIG. 6.

The MAX/MIN extractor 41 receives values of uncorrected pixels b1 to b4 from the line memory 21. The MAX/MIN extractor 41 extracts maximum and minimum values out of those received pixel values. One adder 42 adds up those two extreme pixel values, while the other adder 43 adds up all four pixels b1 to b4. The subtractor 44 subtracts the two-pixel sum output of the adder 42 from the four-pixel sum output of the adder 43. As a result, the output of the subtractor 44 excludes the maximum and minimum pixel values, and that value is supplied to the next adder 34. The rest of the processing goes in the same way as in the foregoing first specific example.

### Third Example of RGB Processor

This section describes a third specific example of the RGB processor 224. Since the third example is mostly similar to the foregoing second example, the description will focus on their differences without repeating the explanation for their shared features. More specifically, the third specific example differs from the second specific example in the number of surrounding pixels referenced during the course of correction processing.

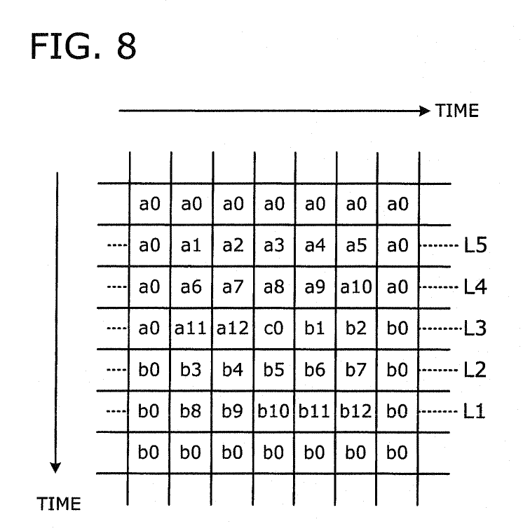

FIG. 8 shows the range of pixels processed by an RGB processor according to the third specific example. Note that FIG. 8 only shows pixels with a particular color for the sake of explanation. It is assumed that pixel c0 is currently selected for correction. Preceding pixels a0 to a12 have already been corrected, while succeeding pixels b0 to b12 have not.

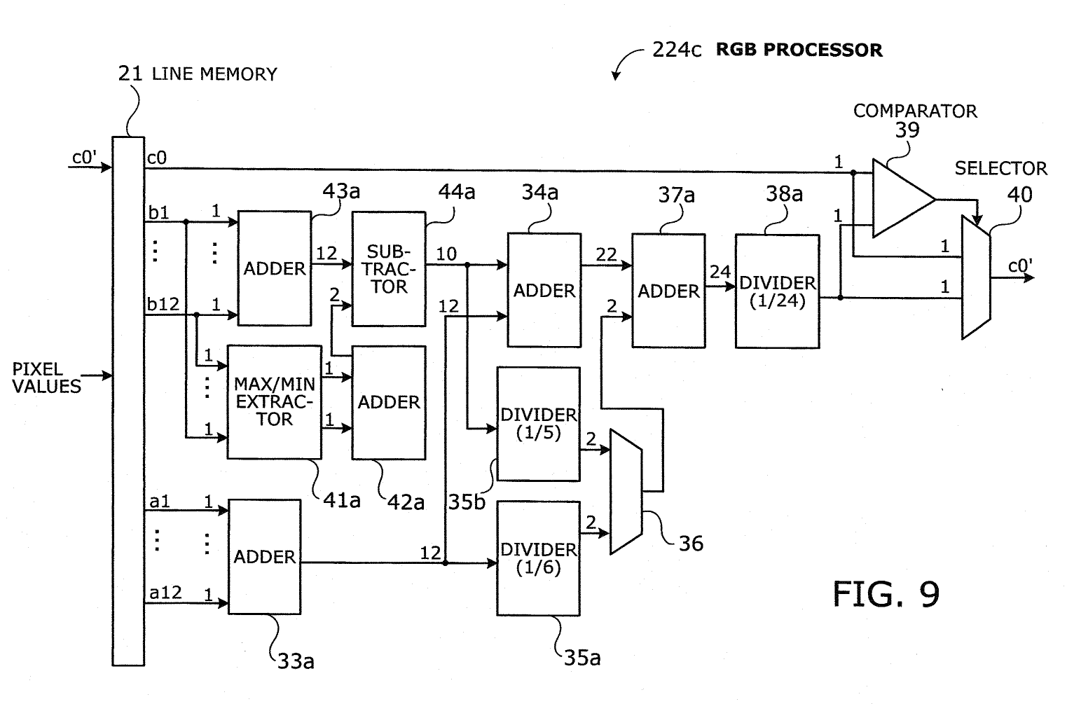

FIG. 9 is a block diagram of an RGB processor 224c according to the third specific example. Suppose that the logic circuit 22 has pixel values of lines L1 and L2 supplied via the column counter 19, along with those of lines L3, L4, and L5 supplied from the line memory 21. In addition to the value of pixel c0, the RGB processor 224c receives values of its surrounding pixels a1 to a12 and b1 to b12. The preceding pixels a1 to a12 have already corrected by the RGB processor 224c and are now fed back to the RGB processor 224c, whereas the succeeding pixels b1 to b12 have not been corrected.

According to the third specific example, the RGB processor 224c is formed from the following elements: a MAX/MIN extractor 41a, five adders 42a, 43a, 33a, 34a, and 37a, a subtractor 44a, three dividers 35a, 35b, and 38a, two selectors 36 and 40, and a comparator 39.

The RGB processor 224c removes maximum and minimum values from the group of succeeding pixels and compensates for them with appropriate alternatives as in the second specific example. That is, the subtractor 44a outputs the sum of ten remaining pixels values. The divider 35b divides this sum by five, thus producing an average two-pixel sum for selection at the subsequent selector 36. Other elements of the RGB processor 224c operate in the same way as in the foregoing second specific example; this section does not repeat the explanation for such elements.

As can be seen from the above-described example, the RGB processor 224c can handle an increased number of pixels just in the same way as in the case of fewer pixels.

### CONCLUSION

To summarize the above discussion, the proposed solid-state imaging device and pixel correction method are designed to correct pixel values using the average of their surrounding pixels with the same color. For precise correction, the proposed device and method reject maximum and minimum pixel values found in the uncorrected pixels preceding the currently selected pixel, thereby protecting average values from being contaminated by undesired defects or noises.

The present invention should not be limited to the specific embodiments described with reference to accompanying drawings. Each element of the proposed solid-state imaging device and pixel correction method may be replaced with any other element that performs equivalent functions. For example, the present invention can be applied not only to images in RGB Bayer pattern, but also to those in other format, such as pictures taken with a complimentary color mosaic filter. The present invention may also be modified to remove not only the maximum and minimum pixel values, but also the second to the maximum value and the second to the minimum value, and compensate later for all those removed values.

The foregoing is considered as illustrative only of the principles. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A solid-state imaging device capable of correcting defective pixel signals, the device comprising:
a line memory that provides values of a pixel currently selected for correction and surrounding pixels thereof, the surrounding pixels including corrected pixels preceding the selected pixel and uncorrected pixels succeeding the selected pixel;
an extreme value remover that removes effectively a maximum pixel value and a minimum pixel value from the values of the corrected pixels read out of the line memory;
an average calculator that receives the remaining values of the uncorrected pixels from the extreme value remover, as well as the values of the corrected pixels from the line memory, and calculates an average value of all the pixel values received; and
a comparison processor that compares the value of the currently selected pixel with the average value calculated by the average calculator and, if a difference therebetween exceeds a predetermined threshold, replaces the value of the currently selected pixel with the average value.

2. The solid-state imaging device according to claim 1, wherein the average calculator comprises:
an adder that outputs a sum of the remaining values of the uncorrected pixels supplied from the extreme value remover; and
a divider that divides the output of the adder to calculate the average value.

3. The solid-state imaging device according to claim 2, wherein the adder comprises a compensation unit that compensates the output of the adder by using either the values of the preceding pixels or the remaining values of the uncorrected pixels supplied from the extreme value remover, such that the number of pixel values contained in the output of the adder will be a power of 2.

4. A method of correcting defective pixel signals of a solid-state imaging device, comprising:
receiving values of a pixel currently selected for correction and surrounding pixels thereof, the surrounding pixels including corrected pixels preceding the selected pixel and uncorrected pixels succeeding the selected pixel;
removing effectively a maximum pixel value and a minimum pixel value from the received values of the corrected pixels;
calculating an average value of the corrected pixels and the uncorrected pixels from which the maximum and minimum pixel values have been removed; and
comparing the value of the currently selected pixel with the average value and, if a difference therebetween exceeds a predetermined threshold, replacing the value of the currently selected pixel with the average value.
